(19) United States
(12) Patent Application Publication
(10) Pub. No.: US 2019/0171414 A1
(43) Pub. Date: Jun. 6, 2019

(54) SYSTEMS AND METHODS FOR ENABLING USER VOICE INTERACTION WITH A HOST COMPUTING DEVICE

(71) Applicant: Google LLC, Mountain View, CA (US)

(72) Inventors: Asaf Zomet, Jerusalem (IL); Michael Shynar, Tel Aviv (IL)

(21) Appl. No.: 16/271,562

(22) Filed: Feb. 8, 2019

Related U.S. Application Data
(63) Continuation of application No. 14/664,323, filed on Mar. 20, 2015.

(51) Int. Cl. G06F 3/16; H04L 29/08; G06F 16/957

(52) U.S. Cl. CPC G06F 3/167; G06F 16/957; H04L 67/10

(57) ABSTRACT

A content management computing device for managing voice-interactive online content includes a memory for storing data and a processor in communication with the memory. The processor is programmed to retrieve an online content item including content metadata, identify at least one voice interaction associated with the content metadata, serve the online content item to a user computing device, wherein serving the online content item further comprises instructing the user computing device to collect voice response data that is responsive to at least one voice interaction, receive the voice response data from the user computing device, identify a user request based on the voice response data, and transmit a response, based on the user request, to a user account.

### BACKGROUND

This description relates to voice interactions with computing devices, and more particularly, to methods and systems for creating and managing voice interactive content configured to respond to voice interaction from a user.

At least some online content (i.e., content presented to consumers with online publications or online applications) is interactive online content configured to receive hands-on interaction from a user (i.e., an individual to whom the online content is presented) such as mouse-clicks and keyboard entries. Such user interaction may trigger further interactions between the user and the online content provider. For example, in the case of some text or graphical online content (e.g., ads), users may directly respond to offers, request further information, or arrange for follow-up interactions with online content providers.

However, in many cases, users receive online content while otherwise occupied with tasks. In such cases, users may be less able to interact with or otherwise engage with the online content. For example, a user that is driving or jogging and receives online content may not be able to respond to the online content directly because their hands are not free for interaction with the online content. Further, the user also may not be able to record or otherwise remember the details of the online content for later follow-up. Accordingly, methods and systems for delivering online content that allow for interaction in such contexts may be desirable.

### BRIEF DESCRIPTION OF THE DISCLOSURE

In one aspect, a content management computing device for managing voice-interactive online content is provided. The content management computing device includes a memory for storing data and a processor in communication with the memory. The processor is programmed to retrieve an online content item including content metadata, identify at least one voice interaction associated with the content metadata, serve the online content item to a user computing device, wherein serving the online content item further comprises instructing the user computing device to collect voice response data that is responsive to at least one voice interaction, receive the voice response data from the user computing device, identify a user request based on the voice response data, and transmit a response, based on the user request, to a user account.

In another aspect, a computer-implemented method for managing voice-interactive online content is provided. The method is implemented by a content management computing device in communication with a memory. The method includes retrieving an online content item including content metadata, identifying at least one voice interaction associated with the content metadata, serving the online content item to a user computing device, wherein serving the online content item further comprises instructing the user computing device to collect voice response data that is responsive to at least one voice interaction, receiving the voice response data from the user computing device, identifying a user request based on the voice response data, and transmitting a response, based on the user request, to a user account.

In another aspect, a computer-readable storage device having processor-executable instructions embodied thereon, for managing voice-interactive online content is provided. When executed by a computing device, the processor-executable instructions cause the computing device to retrieve an online content item including content metadata, identify at least one voice interaction associated with the content metadata, serve the online content item to a user computing device, wherein serving the online content item further comprises instructing the user computing device to collect voice response data that is responsive to at least one voice interaction, receive the voice response data from the user computing device, identify a user request based on the voice response data, and transmit a response, based on the user request, to a user account.

In yet another aspect, a computer-implemented method for serving voice-interactive online content on a user computing device is provided. The method is implemented by the user computing device. The user computing device is in communication with a memory. The method includes receiving an online content item from a content management computing device, wherein the online content item includes content metadata, identifying at least one voice interaction associated with the content metadata, serving the online content item via a user output interface, collecting voice response data from a user input interface that is responsive to at least one voice interaction, and transmitting the voice response data to the content management computing device.

In another aspect, a system for managing voice-interactive online content is provided. The system includes means for retrieving an online content item including content metadata. The system also includes means for identifying at least one voice interaction associated with the content metadata. The system additionally includes means for serving the online content item to a user computing device, wherein serving the online content item further comprises instructing the user computing device to collect voice response data that is responsive to at least one voice interaction. The system also includes means for receiving the voice response data from the user computing device. The system further includes means for identifying a user request based on the voice response data. The system also includes means for transmitting a response, based on the user request, to a user account.

In another aspect, the system described above is provided, wherein the system further includes means for transmitting a request for additional voice response data to the user account upon determining, based on the user request, that further input is required.

In another aspect, the system described above is provided, wherein the system further includes means for processing the voice response data into a set of text data using a speech processing algorithm, and means for identifying the user request from the set of text data by applying at least one of a regular expression algorithm and a context-free grammar algorithm.

In another aspect, the system described above is provided, wherein the system further includes means for determining that the user request represents a request for an offer, means for retrieving a set of user profile information associated with the user computing device including at least a set of contact data, and means for using the set of user profile information to generate the response.

In another aspect, the system described above is provided, wherein the system further includes means for determining that the user request represents a request for a purchase, means for identifying a set of purchase data from the user request defining the request for the purchase, means for retrieving a set of user payment information associated with the user computing device, and means for transmitting the set of purchase data and the set of user payment information to the online content provider.

In another aspect, the system described above is provided, wherein the system further includes means for transmitting a security request to the user account to verify that the request for the purchase is authorized, means for receiving a security response from the user computing device, and means for verifying that the request for the purchase is authorized.

In another aspect, the system described above is provided, wherein the system further includes means for determining that the user request represents a request for a scheduled event, means for identifying a set of calendar options associated with the user computing device, and means for transmitting the request for a scheduled event including the set of calendar options.

In another aspect, the system described above is provided, wherein the system further includes means for determining that the user request represents a request for more information, means for identifying a second online content item associated with the online content item, wherein the second online content item includes more information than the online content item, and means for serving the second online content item to the user account.

In another aspect, a system for serving voice-interactive online content is provided. The system includes means for receiving an online content item from a content management computing device, wherein the online content item includes content metadata. The system also includes means for identifying at least one voice interaction associated with the content metadata. The system further includes means for serving the online content item via a user output interface. The system additionally includes means for collecting voice response data from a user input interface that is responsive to at least one voice interaction. The system also includes means for transmitting the voice response data to the content management computing device.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a diagram depicting an example online content environment;

FIG. 2 is a block diagram of a computing device, used for managing, providing, displaying, and analyzing voice-interactive online content, as shown in the online content environment of FIG. 1;

FIG. 3 is an example data flowchart of managing and providing voice-interactive online content using the computing device of FIG. 2 in the online content environment shown in FIG. 1;

FIG. 4 is an example method for managing and providing voice-interactive online content using the online content environment of FIG. 1;

FIG. 5 is an example method for displaying and providing voice-interactive online content to the user computing device of FIG. 2 using the online content environment of FIG. 1; and

FIG. 6 is a diagram of components of one or more example computing devices that may be used in the environment shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of implementations refers to the accompanying drawings. The same reference numbers in different drawings may identify the same or similar elements. Also, the following detailed description does not limit the claims.

The systems and methods described herein overcome described challenges of delivering interactive online content by serving online content configured to receive user voice interaction. More specifically, in the example embodiment, the systems and methods are implemented by a content management computing device configured to: (i) retrieve an online content item including content metadata, (ii) identify at least one voice interaction associated with the content metadata, (iii) serve the online content item to a user computing device, wherein serving the online content item further includes instructing the user computing device to collect voice response data that is responsive to at least one voice interaction, (iv) receive the voice response data from the user computing device, (v) identify a user request based on the voice response data, and (vi) transmit a response, based on the user request, to a user account.

As described and suggested above, the systems and methods thereby achieve several technical effects. First, the systems and methods described allow users to engage with online content at a delay. As described above, much existing online content requests immediate user interaction even when it is impractical. The systems and methods described herein allow a user to delay the interaction to a time when the user may more conveniently interact with the systems. For example, users may receive an online content message and use the methods and systems to receive follow-up messages (e.g., an email message) to re-engage with the online content provider at a later time. Second, the systems and methods described provide mechanisms and infrastructure that may be used to define, create, manage, and serve interactive content and to additionally receive, process, and analyze user voice response data. As a result, the systems and methods solve the technological problem of accessing user interaction data responsive to interactive online content in contexts when known interaction data is otherwise inaccessible. This technological problem of data access, specific to the context of computer networks (and further specific to the context of content serving), is solved in the embodiments and the technical implementations described herein. Third, the systems and methods improve the technical field of content serving. By utilizing the infrastructure and systems described, the content management computing device accesses interaction content that is otherwise unavailable to content servers, publishers, and other parties. Through the use of the described content metadata in the online content items, the content management computing device identifies at least one voice interaction associated with the content metadata and serves the online content item to a user computing device, wherein serving the online content item further includes instructing the user computing device to collect voice response data that is responsive to at least one voice interaction. As a result, the content metadata facilitates the receipt of such otherwise inaccessible information. Fourth, the systems and methods described herein provide new solutions that are of unique value in the context of computer networks and, more specifically, the context of content serving.

In one aspect, the methods described are implemented by a content management computing device. The content management computing device is configured to retrieve, manage, and serve an online content item such as an online advertisement. The online content item may be of any suitable format including text, graphical, audio, video, or any combination thereof. In the example embodiment, the online content item includes at least some audio content. In some embodiments, the online content item may not include audio content while remaining responsive to voice interactions.

The online content item includes content metadata. The content metadata includes a description of voice interactions that may be associated with the online content item. For example, the voice interactions may include voice commands to which the online content item is responsive. In one example, the online content item may be configured to respond to user voice commands such as “Tell Me More”, “Send Me Information”, and “Buy Now.” Further, as described in detail below, such content metadata may allow for detailed description of voice interactions associated with the online content. Such content metadata may be analyzed, parsed, and processed by multiple systems to determine which voice interactions are associated with the online content item. In one embodiment, the content management computing device is configured to parse the content metadata and determine which voice interactions are associated with the online content item. In other embodiments, client systems such as the user computing device may parse the content metadata and determine which voice interactions are associated with the online content item.

The content management computing device serves the online content item (e.g., an ad) to a user computing device (“user computing device”). More specifically, the online content item provides the online content item to the user computing device in the context of an online publication. In the example embodiment, the online publication is audio content and the online content item is served within the audio content. In one example, the online publication is a music stream and the online content item is served between songs of the music stream.

As described herein, during the serving of the online content item, the content management computing device also instructs the user computing device to monitor for user feedback that may be associated with the voice interactions. In other words, the content management computing device instructs the user computing device to collect voice response data that is responsive to at least one voice interaction defined by the content metadata. Therefore, in the examples above, the content management computing device may instruct the user computing device to monitor for a user speaking commands including, “Tell Me More”, “Send Me Information”, and “Buy Now.” Such examples are described in detail below.

In the example embodiment, the user computing device receives such voice response data and transmits the voice response data to the content management computing device. Accordingly, the content management computing device receives the voice response data from the user computing device. In at least some examples, the user computing device may transmit the voice response data to the content management computing device in real time. In other examples, the user computing device may transmit the voice response data at periodic intervals or when suitable data connectivity is available.

The content management computing device further processes the voice response data to identify textual information. In the example embodiment, the content management computing device may use any suitable audio processing algorithm to identify the textual information. Further, the content management computing device processes the textual information using a language processing algorithm to identify a user request. The user request, or user intent, represents the action intended by the user. The content management computing device also transmits the user request to the online content provider associated with the online content item.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

Described herein are computer systems such as content management computing devices, user computing devices and related computer systems. As described herein, all such computing devices and computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As described above and herein, in some embodiments, the content management computing device may store user computing device identifiers, user identifiers, geographic identifiers associated with users, and transaction and shopping data associated with users, without including sensitive personal information, also known as personally identifiable information or PII, in order to ensure the privacy of individuals associated with the stored data. Personally identifiable information may include any information capable of identifying an individual. For privacy and security reasons, personally identifiable information may be withheld and only secondary identifiers may be used. For example, data received by the content management computing device may identify user “John Smith” as user “ZYX123” without any method of determining the actual name of user “ZYX123”. In some examples where privacy and security can otherwise be ensured (e.g., via encryption and storage security), or where individuals consent, personally identifiable information may be received and used by the content management computing device. In such examples, personally identifiable information may be needed to reports about groups of online users. In situations in which the systems discussed herein collect personal information about individuals including online users and merchants, or may make use of such personal information, the individuals may be provided with an opportunity to control whether such information is collected or to control whether and/or how such information is used. In addition, certain data may be processed in one or more ways before it is stored or used, so that personally identifiable information is removed. For example, an individual's identity may be processed so that no personally identifiable information can be determined for the individual, or an individual's geographic location may be generalized where location data is obtained (such as to a city, ZIP code, or state level), so that a particular location of an individual cannot be determined.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “online content” may refer to any form of communication in which one or more products, services, ideas, messages, people, organizations or other items are identified and/or promoted (or otherwise communicated). “Online content” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed publications, or any other form of information that may be presented to a user using a computing device. In one embodiment, “online content” may refer to advertisements (“ads”).

Ads are not limited to commercial promotions or other communications. An ad may be a public service announcement or any other type of notice, such as a public notice published in printed or electronic press or a broadcast. An ad may be referred to as sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device or otherwise played on a user access device. An ad group refers, for example, to an entity that represents a group of creatives that share a common characteristic, such as having the same ad selection and recommendation criteria. Ad groups can be used to create an ad campaign.

As used herein, “content metadata” may refer to “data about data” that describes voice interactions that may be associated with content such as online content. Specifically, such content metadata may be descriptive metadata describing individual instances of voice interactions that may be associated with particular online content.

As used herein, “voice interactions” and related terms may refer to any interactions that may be associated with online content. In the example embodiment, content metadata describes voice interactions that may be associated with particular online content. The systems described cause the user computing device to monitor for and capture voice responses received by a user in conjunction with the display of online content. Such voice responses are captured by the user computing device as “voice response data.”

The systems and processes are not limited to the specific embodiments described herein. In addition, components of each system and each process can be practiced independent and separate from other components and processes described herein. Each component and process also can be used in combination with other assembly packages and processes.

As described above, the content metadata used by the systems defines at least one voice interaction that may be associated with online content. Such voice interaction is identified and used to capture voice response data at the user computing device. In an example embodiment, an example of descriptive content metadata is given in the example below (Table 1):

TABLE 1

| Online | | Interaction | Interaction | Email |
|---|---|---|---|---|
| Content ID | Interaction Label | Parameters | Response | Formats |
| ABC123 | SEND_PH_NUMBER | Phone | Provide Hours | Plain Text |
| | | Number | of Operation by | |
| | | | Audio | |
| DEF456 | SEND_PROD_OFFER | Product | Provide Audio | HTML |
| | | Names, | Offer Summary | and Plain |
| | | Product | | Text |
| | | Attributes, | | |
| | | Product | | |
| | | Quantities | | |
| GHI789 | RESERVE_LOCATION | Date, Time, | Audio | HTML |
| | | Location, | Confirmation | and Plain |
| | | Quantity of | | Text |
| | | People | | |
| JKL012 | PRODUCT_PURCHASE | Product | Audio | HTML |
| | | Names, | Confirmation | and Plain |
| | | Product | | Text |
| | | Attributes, | | |
| | | Product | | |
| | | Quantities, | | |
| | | Payment | | |
| | | Method | | |

Table 1 includes four illustrative examples of voice interactions that are each associated with a distinct online content item. As described below and herein, in other examples multiple voice interactions may be associated with a given online content item. However, for simplicity, Table 1 only identifies one voice interaction per online content item. Additionally, the types of voice interactions shown in Table 1 are illustrative but non-limiting. Accordingly, additional voice interactions (including those described below) may be associated with other online content items.

Shown in Table 1, online content item “ABC123” may be an advertisement for a service such as a gym or fitness center. When “ABC123” is displayed to a user on a user computing device, a promotion for a special offer (e.g., a discounted membership to the gym) may be provided along with a request to call the gym now for membership. As described herein, a user may not be able to call the gym at the time of ad serving. As a result, the content management computing device causes the user computing device to allow a user to interact with online content item “ABC123” using voice interaction “SEND_PH_NUMBER” (as identified in “Interaction Label”). When executed, SEND_PH_NUMBER allows a user to request the gym's phone number to be provided to the user. In one example, the user may respond to a voice prompt at the end of the display of “ABC123”. For example, the display of “ABC123” may end with the user computing device providing a message (via visual or audio output) of “Please say yes if you would like our phone number.”

The content management computing device causes the user computing device to listen for a response for a configurable period of time and collect voice response data from a user. In other words, after “ABC123” is displayed, voice interaction SEND_PH_NUMBER begins. In the example embodiment, the content management computing device causes the user computing device to listen for five seconds. In other embodiments, the period of listening may be configured in the content metadata. Alternately, settings of content providers, the content management computing device, and the user computing device may be used to control the period of listening.

Content metadata may also include “Interaction Parameters” that further define the voice interaction. Specifically, Interaction Parameters define the parameters that are monitored for when the content management computing device parses and analyzes the voice response data. In the example embodiment, SEND_PH_NUMBER includes an Interaction Parameter of a Phone Number. As such, the content metadata causes the user computing device to listen for a contact number (e.g., a mobile phone number) to which the gym's phone number may be sent. Upon receiving voice response data of “Yes” (indicating that the user wants the gym's phone number) from the user computing device, the content management computing device sends the phone number of the gym to a message account associated with the user computing device. If the user provides a phone number (responsive to the Interaction Parameter of Phone Number) with text message capabilities, the message may be sent via text. Alternately, the message account associated with the user computing device is an email address associated with the user computing device that is detected by the content management computing device based on previous or current interaction with the user computing device. Therefore, if a phone number is not provided, the gym's phone number may be sent via email. In alternative embodiments, the message account may be any suitable message style including SMS, text message, instant message. In additional embodiments, the response of the system may be sent via applications including web-based applications.

Content metadata may also include an “Interaction Response”. The Interaction Response reflects a follow-up that may occur after the user computing device attempts to collect voice response data. In the given example, Interaction Response includes “Provide Hours of Operation by Audio.” In this example, when the voice response data of “Yes” is collected, the user computing device may provide an audio message with the hours of operation of the gym. In other examples, other forms of follow-up may occur in Interaction Response. In one example, Interaction Response may include a second prompt message that provides a new audio message and listens for an additional voice interaction. For example, the Interaction Response for an alternative form of “ABC123” may cause the user computing device to provide a message of “What type of membership are you interested in?” to a user and listen for a secondary voice interaction. As bandwidth may vary for users (e.g., when a user computing device migrates between data networks), in some examples audio associated with an Interaction Response may be pre-downloaded in order to avoid latency in serving the Interaction Response or alternately to avoid using data networks that are undesirable (e.g., cellular roaming networks).

Content metadata may further include email format types that allow an online content provider to specify a type (or types) of email follow-up that may be sent in response to the user voice response data. In some examples, message accounts may prefer certain email formats (or message formats) and the content management computing device may accordingly match such email format types to message accounts as appropriate.

In the second example, online content item “DEF456” is associated with voice interaction “SEND_PROD_OFFER”. DEF456 includes content describing several product offers promoted by a particular merchant. As suggested, SEND_PROD_OFFER is a voice interaction that causes a user computing device to monitor for a request by a user for details on the product offer. For example, “DEF456” may include audio content describing a sale of apparel and end with a statement, “If you would like to know more about this sale, say, ‘Send Me Details’ and name the products you want to hear about!” The content management computing device, upon parsing and analyzing DEF456 and identifying SEND_PROD_OFFER, causes user computing device to serve DEF456 and listen for a user response of “Send Me Details” within the designated period of listening. In SEND_PROD_OFFER, Interaction Parameters include Product Names, Product Attributes, and Product Quantities. Therefore, the content management computing device causes the user computing device to listen for such parameters in the voice response data. Upon completion, SEND_PROD_OFFER also provides an Audio Offer Summary describing the available offers. In the example, SEND_PROD_OFFER may be sent in plain text email or HTML email.

In the third example, online content item “GHI789” is associated with voice interaction “RESERVE_LOCATION”. “GHI789” includes content describing service offerings for a business such as a restaurant. As suggested, RESERVE_LOCATION is a voice interaction that causes user computing device to monitor for a user request for a reservation at the advertising business. For example, “GHI789” may include audio content describing a special deal at a restaurant and end with the statement, “Make your reservation now!” RESERVE_LOCATION includes several Interaction Parameters including Date, Time, Location, and Quantity of People. In one example, content management computing device causes the user computing device to listen for such interaction parameters and create a reservation at the restaurant if possible. In a second example, user computing device may be in communication with a user calendar. In such examples, user computing device may identify and access the user calendar and identify openings on the user calendar that may be provided to the restaurant. In at least some examples, RESERVE_LOCATION may also include follow-up requests for information not present in the calendar including, for example, Quantity of People.

In a fourth example, online content item “JKL012” is associated with voice interaction “PRODUCT_PURCHASE”. “JKL012” includes content describing service offerings for a product that may be purchased. Although JKL012 is similar to DEF456, PRODUCT_PURCHASE allows a user to specifically request to purchase a product or products. In contrast to SEND_PROD_OFFER, PRODUCT_PURCHASE also collects the Interaction Parameter of Payment Method and thereby allows a user computing device to provide payment data. In a first example, Payment Method is provided based on user voice interaction. In a second example, Payment Method is provided through the user computing device or software associated with the user computing device including, for example, an electronic wallet or a web-based wallet. In such examples, content management computing device may also require the user computing device to receive a security input (e.g., a password or a PIN code) to validate that the user has access to the payment method specified in Payment Method.

In alternative examples, as described above, the content management computing device facilitates delayed interaction between the user and the online content provider. In a first example (such as the example of online content item “JKL102” associated with voice interaction “PRODUCT_PURCHASE”), the content management computing device (or an associated device including an online content provider computing device) may send order details to the user. Such order details may be sent to the user via email or any other suitable medium. Order details may be sent to the user computing device or additional computing devices accessible to the user. Upon receipt, the order details are configured to allow the user (via the accessed computing device) to review and approve, cancel, or modify the order by interaction with the order details.

In a second example, (such as the example of online content item “GHI789” associated with voice interaction “RESERVE_LOCATION”), the content management computing device (or an associated device including an online content provider computing device) may send reservation details to the user. Such reservation details may be sent to the user via email or any other suitable medium. Reservation details may be sent to the user computing device or additional computing devices accessible to the user. Upon receipt, the reservations details are configured to allow the user (via the accessed computing device) to review and approve, cancel, or modify the reservation by interaction with the order details.

As described herein, alternative voice interactions and combinations of voice interactions may be provided. Further additional Interaction Parameters may be collected for the above voice interaction types or any alternative types.

As described above and herein, the content management computing device is configured to transmit a response, based on the user request to an account (“user account”) that is associated with the user. As indicated above, such responses may include a message with contact information for an online content provider, confirmation of reservation details, confirmation of order details, offer details, or any other follow-up message created based on the voice interaction. The user account may be any account associated with the user identified based on user features such as a user profile. In one example, the user account is an online application account. In a second example, the user account is an email account. In a third example, the user account is a messaging account for any suitable messaging protocol. As described herein, the user account may be accessed via the user computing device or other computing devices including secondary user computing devices, as described below.

Described above and in Table 1 are several variations on voice interaction types that may be used in content metadata that is associated with online content. In addition to the descriptive content metadata described, structural metadata and associated syntax is also defined so that online content may use consistent data formats and structures in communicating with content management computing device and/or user computing device.

Structural metadata may be provided by the content management computing device to online content publishers and online content providers (e.g., advertisers). Such structural metadata may also include acceptable metadata syntax. In some examples, structural metadata is defined and provided including standardization tools including but not limited to controlled vocabularies, taxonomies, thesauri, data dictionaries, and metadata registries. The structural metadata may be provided using any suitable format including plain text, rich data format (RDF), hypertext markup language (HTML), and extensible markup language (XML).

In an example embodiment, the structural metadata defines a set of acknowledged voice interaction types, parameters associated with each voice interaction type, interaction response associated with each voice interaction type, and email format associated with each voice interaction type. Further, structural metadata defines the layout, format, and syntax of the content metadata.

As described above, multiple parties may receive structural metadata that may be used to create content metadata. In at least one example, content providers (e.g., advertisers) may create content metadata and embed such content metadata within online content items. In other examples, content publishers, the content management computing device, and other parties may create content metadata and embed such content metadata within online content items. In one example, content providers may send a request to the content management computing device. The request may be for particular online content items created by the content provider to be modified to include specific voice response data. In such an example, the content management computing device may edit the online content to include voice interaction metadata.

As described above, multiple systems may analyze online content to determine that content metadata is present. In the example embodiment, the content management computing device may scan online content items to identify content metadata. Because content metadata is structured in a manner specified or promulgated by the content management computing device, the content management computing device can recognize such content metadata. Specifically, content metadata records at least one version of content metadata formats and definitions in a memory or accessible storage that may be used when scanning online content items.

Upon identifying that content metadata is present within an online content item, the content management computing device analyzes the content metadata to identify a voice interaction or voice interactions associated with the online content item. Further, the content management computing device may identify Interaction Parameters, Email Formats, and Interaction Responses associated with the online content item. Such identified voice interactions and other attributes are used when the content management computing device serves the online content item to a user computing device. Specifically, as described, the content management computing device serves online content items to the user computing device and sends an instruction to the user computing device to listen or monitor for voice response data for a period after serving the online content items. Further, the content management computing device sends an instruction to the user computing device to transmit collected voice response data back to the content management computing device upon collection. Also, the content management computing device may send an instruction to additionally serve an Interaction Response depending upon the voice response data collected.

In at least some examples, the content management computing device may also use the user computing device to identify and analyze content metadata. In such examples, the user computing device at least partially identifies, parses, and analyzes content metadata and determines how to serve voice response data associated with the content metadata. Accordingly, the user computing device at least partially serves voice interactions with the online content item. In such examples, the content management computing device may provide the user computing device with programming (e.g., scripts, plug-ins, or apps) that may be used to identify and serve voice interactions.

Upon collection of the voice response data, the user computing device transmits such voice response data to the content management computing device. The content management computing device processes the voice response data to identify a user request. Phrased differently, the content management computing device processes the voice response data in light of the voice interactions (as shown in, for example, Table 1) and identifies the meaning of the voice response data. In one example, the content management computing device processes the voice response data into a set of text data using a speech processing algorithm and additionally identifies the user request from the set of text data by applying at least one of a regular expression algorithm and a context-free grammar algorithm.

In some examples, the content management computing device may access user profile information associated with the user computing device. Such user profile information may include, for example, user calendar information, user contact information, and user payment information. In at least one example the content management computing device determines that a user request, identified based on voice response data, represents a request for an offer. For example, the content management computing device may determine that voice response data is responsive to SEND_PROD_OFFER (shown in Table 1, above.) In such examples, the content management computing device may also retrieve a set of user profile information associated with the user computing device including at least a set of contact data, and use the set of user profile information to generate the response.

In another example, the content management computing device may specifically access user payment information (e.g., data associated with Payment Method, shown above) associated with the user computing device. For example, the user computing device may determine that the user request represents a request for a purchase because the voice response data is responsive to voice interaction PRODUCT_PURCHASE (shown in Table 1, above.) The content management computing device may also identify a set of purchase data from the user request defining the request for the purchase. In other words, the content management computing device may identify the terms of the purchase requested in the voice response data (e.g., the products sought for purchase and quantities). The content management computing device may also retrieve a set of user payment information associated with the user device and transmit the set of purchase data and the set of user payment information to the online content provider. As a result, the content management computing device may allow the online content provider to sell merchandise based on the voice response data collected.

In some examples, use of payment data may have security restrictions. In at least one example, the content management computing device is configured to transmit a security request to the user device to verify that the request for the purchase is authorized. For example, the content management computing device may send a request for authentication based on a passphrase, biometric data, a PIN code, or any other suitable security protocol. In the example embodiment, the content management computing device sends a general request for the user computing device to authenticate the user without requesting actual secure data. In this example, the content management computing device receives a security response from the user device indicating whether a user is authorized for purchasing goods or services (but not indicating private information of the user.) The content management computing device verifies that the request for the purchase is authorized.

In some examples, the user computing device may also be used to analyze collected voice response data. For example, by using a client-server architecture, the content management computing device may provide the user computing device with software or other tools that may process voice response data on the user computing device. Accordingly, the user computing device may analyze the voice response data and send the parsed and analyzed data to the content management computing device in a non-audio format such as a text file. In such examples, lower data consumption may be employed because voice data files are not transmitted from the user computing device to the content management computing device.

In some examples, the content management computing device may determine that the voice response data is incomplete. For example, information collected may not be fully responsive to the voice interaction. In such examples, the content management computing device may determine that such voice response data is incomplete and further transmit a request for additional voice response data to the user device upon determining, based on the user request, that further input is required. In some embodiments, the user computing device may also be configured to analyze voice response data and determine whether a request for additional voice response data is required.

In some examples, the content management computing device may also determine that the user request represents a request for a scheduled event. For example, the user computing device may determine that the user request represents a request for a scheduled event because the voice response data is responsive to voice interaction RESERVE_LOCATION (shown in Table 1, above). In such examples, the content management computing device may determine that the user request represents a request for a scheduled event, identify a set of calendar options associated with the user device, and transmit the request for a scheduled event including the set of calendar options. Identification of the set of calendar options may be performed by retrieving user profile information including a user calendar.

In further examples, the content management computing device is configured to determine that the user request represents a request for more information. For example, a user may provide a response to a voice interaction that is a question requesting more information in return. In such examples, the content management computing device may identify a second online content item associated with the online content item, wherein the second online content item includes more information than the online content item and serve the second online content item to the user device.

Based on the user request, the content management computing device may identify at least one response. For example, based on a user request associated with SEND_PH_NUMBER, the content management computing device may determine that the at least one response includes sending a phone number associated with the online content item to the user computing device. In the case of a user request associated with SEND_PROD_OFFER, the content management computing device may determine that the at least one response includes sending a product offer for products identified by the user in the voice response data. In the case of a user request associated with RESERVE_LOCATION, the content management computing device may determine that the at least one response includes sending a request for a reservation to the online content provider (e.g., the merchant) and also sending a confirmation to the user computing device upon determining that the merchant can accommodate the reservation. In the case of a user request associated with PRODUCT_PURCHASE, the content management computing device may determine that the at least one response includes sending a request for purchase to the online content provider (e.g., the merchant) and also sending a confirmation to the user computing device upon processing the purchase. Alternately, in some examples, the content management computing device may determine that the at least one response includes sending a request for purchase to the online content provider (e.g., the merchant) and also sending a confirmation to a secondary user computing device (distinct from the user computing device) upon processing the purchase. Sending the at least one response to the secondary user computing device substantially facilitates allowing a user to interact with the online content provider at a delay and using multiple computing devices. As described above, in many examples a user may prefer to interact with the online content provider (and online content item) using a different device and at a different time. Similarly, in all examples described herein, the content management computing device may be configured to communicate with such secondary user computing devices. Because different computing devices have different display and interaction characteristics (e.g., varying screen sizes and input interfaces), users may prefer interaction to be redirected from the user computing device to such secondary user computing devices.

In at least some examples, the content management computing device is configured to receive requests to redirect communications including responses to such secondary user computing devices. For example, the content management computing device may identify secondary user computing devices based on user profile information or alternately based on voice response data. Accordingly, in some examples, the content management computing device requests information from the user profile to identify a set of contact information including information identifying secondary user computing devices or methods of contacting such secondary user computing devices (including, for example, email addresses, account names, and other identifiers). In other examples, the voice interactions (such as those described) may be configured to prompt the user to identify secondary user computing devices in voice interactions. Accordingly, the content management computing device is configured to transmit the response based on the set of contact information to such secondary user computing devices. As a result, the content management computer device allows the user (via the secondary user computing device or any other computing device) to interact with the response at a delay in comparison to the time of initially serving the online content item.

As described herein, the user computing device is also configured to execute several steps to display voice interactive content. Specifically, the user computing device is configured to at least: (i) receive an online content item from a content management computing device, wherein the online content item includes content metadata; (ii) identify at least one voice interaction associated with the content metadata; (iii) serve the online content item via a user output interface; (iv) collect voice response data from a user input interface that is responsive to at least one voice interaction; and (v) transmitting the voice response data to the content management computing device.

In some embodiments, the user computing device is also configured to receive a second online content item, determine that the second online content item should be served based upon the collected voice response data, and serve the second online content item via the user output interface.

The methods and systems described herein may be implemented using computer programming or engineering techniques including computer software, firmware, hardware or any combination or subset thereof, wherein the technical effects may be achieved by performing one of the following steps: (a) retrieving an online content item including content metadata; (b) identifying at least one voice interaction associated with the content metadata; (c) serving the online content item to a user computing device, wherein serving the online content item further comprises instructing the user computing device to collect voice response data that is responsive to at least one voice interaction; (d) receiving the voice response data from the user computing device; (e) identifying a user request based on the voice response data; (f) transmitting a response, based on the user request, to device user account; (g) transmitting a request for additional voice response data to the user account upon determining, based on the user request, that further input is required; (h) processing the voice response data into a set of text data using a speech processing algorithm; (i) identifying the user request from the set of text data by applying at least one of a regular expression algorithm and a context-free grammar algorithm; (j) determining that the user request represents a request for an offer; (k) retrieving a set of user profile information associated with the user computing device including at least a set of contact data; (l) using the set of user profile information to generate the response; (m) determining that the user request represents a request for a purchase; (n) identifying a set of purchase data from the user request defining the request for the purchase; (o) retrieving a set of user payment information associated with the user computing device; (p) transmitting the set of purchase data and the set of user payment information to the online content provider; (q) transmitting a security request to the user account to verify that the request for the purchase is authorized; (r) receiving a security response from the user computing device; (s) verifying that the request for the purchase is authorized; (t) determining that the user request represents a request for a scheduled event; (u) identifying a set of calendar options associated with the user computing device; (v) transmitting the request for a scheduled event including the set of calendar options; (w) determining that the user request represents a request for more information; (x) identifying a second online content item associated with the online content item, wherein the second online content item includes more information than the online content item; and (y) serving the second online content item to the user account.

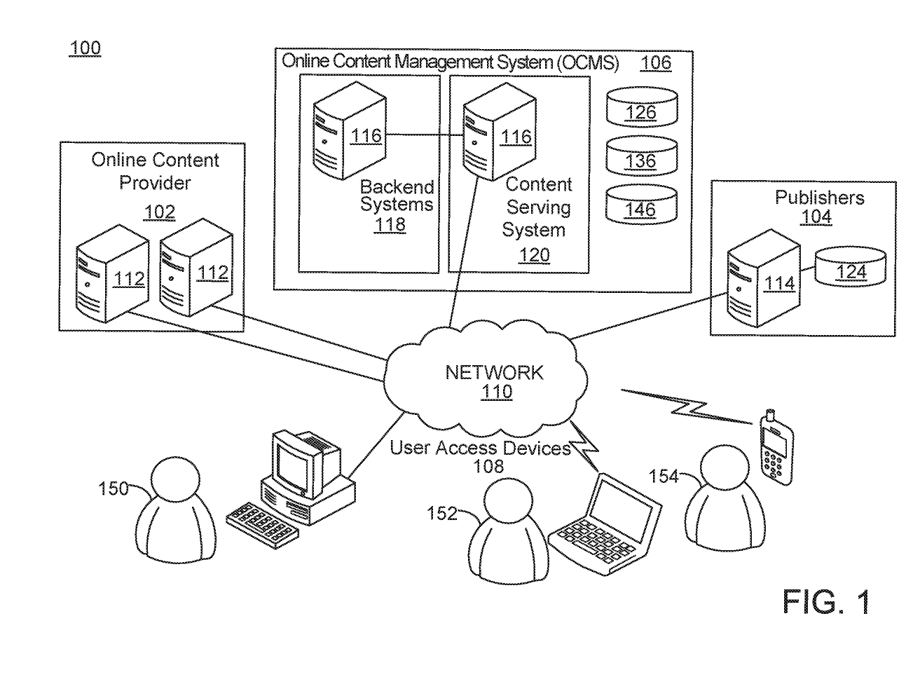

FIG. 1 is a diagram depicting an example online content environment 100. Online content environment 100 may be used in the context of serving online advertisements to a user, including a user of a mobile computing device, in combination with online publications. With reference to FIG. 1, example environment 100 may include one or more online content providers 102 (e.g., advertisers), one or more publishers 104, an online content management system (OCMS) 106, and one or more user access devices 108, which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an advertisement distribution network. While reference is made to distributing advertisements, the environment 100 can be suitable for distributing other forms of content including other forms of sponsored content. OCMS 106 may also be referred to as a content management system 106.

The online content providers 102 may include any entities that are associated with online content such as advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to as sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

The online content providers 102 may provide (or be otherwise associated with) products and/or services related to ads. The online content providers 102 may include or be associated with, for example, retailers, wholesalers, warehouses, manufacturers, distributors, health care providers, educational establishments, financial establishments, technology providers, energy providers, utility providers, or any other product or service providers or distributors.

The online content providers 102 may directly or indirectly generate, and/or maintain ads, which may be related to products or services offered by or otherwise associated with the advertisers. The online content providers 102 may include or maintain one or more data processing systems 112, such as servers or embedded systems, coupled to the network 110. The online content providers 102 may include or maintain one or more processes that run on one or more data processing systems.

The publishers 104 may include any entities that generate, maintain, provide, present and/or otherwise process content in the environment 100. “Publishers,” in particular, include authors of content, wherein authors may be individual persons, or, in the case of works made for hire, the proprietor(s) who hired the individual(s) responsible for creating the online content. The term “content” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed publications, or any other form of information that may be presented to a user using a computing device such as one of user access devices 108.

In some implementations, the publishers 104 may include content providers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other content providers. One or more of the publishers 104 may represent a content network that is associated with the OCMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with additional sets of content, for example ads, that are related or relevant to the retrieved content for display to users 150, 152, and 154. As discussed further below, these relevant ads may be provided from the OCMS 106 and may be combined with content for display to users 150, 152, and 154. In some examples, the publishers 104 may retrieve content for display on a particular user access device 108 and then forward the content to the user access device 108 along with code that causes one or more ads from the OCMS 106 to be displayed to the user 150, 152, or 154. As used herein, user access devices 108 may also be known as customer computing devices 108. In other examples, the publishers 104 may retrieve content, retrieve one or more relevant ads (e.g., from the OCMS 106 or the online content providers 102), and then integrate the ads and the article to form a content page for display to the user 150, 152, or 154.

As noted above, one or more of the publishers 104 may represent a content network. In such an implementation, the online content providers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The OCMS 106 manages ads and provides various services to the online content providers 102, the publishers 104, and the user access devices 108. The OCMS 106 may store ads in an ad repository 126 and facilitate the distribution or selective provision and recommendation of ads through the environment 100 to the user access devices 108. In some configurations, the OCMS 106 may include or access functionality associated with managing online content and/or online advertisements, particularly functionality associated with serving online content and/or online advertisements to mobile computing devices.

The OCMS 106 may include one or more data processing systems 116, such as servers or embedded systems, coupled to the network 110. It can also include one or more processes, such as server processes. In some examples, the OCMS 106 may include an ad serving system 120 and one or more backend processing systems 118. The ad serving system 120 may include one or more data processing systems 116 and may perform functionality associated with delivering ads to publishers or user access devices 108. The backend processing systems 118 may include one or more data processing systems 116 and may perform functionality associated with identifying relevant ads to deliver, processing various rules, performing filtering processes, generating reports, maintaining accounts and usage information, and other backend system processing. The OCMS 106 can use the backend processing systems 118 and the ad serving system 120 to selectively recommend and provide relevant ads from the online content providers 102 through the publishers 104 to the user access devices 108.

The OCMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The OCMS 106 may include one or more interface or frontend modules for providing the various features to advertisers, publishers, and user access devices. For example, the OCMS 106 may provide one or more publisher front-end interfaces (PFEs) for allowing publishers to interact with the OCMS 106. The OCMS 106 may also provide one or more advertiser front-end interfaces (AFEs) for allowing advertisers to interact with the OCMS 106. In some examples, the front-end interfaces may be configured as web applications that provide users with network access to features available in the OCMS 106.

The OCMS 106 provides various advertising management features to the online content providers 102. The OCMS 106 advertising features may allow users to set up user accounts, set account preferences, create ads, select keywords for ads, create campaigns or initiatives for multiple products or businesses, view reports associated with accounts, analyze costs and return on investment, selectively identify customers in different regions, selectively recommend and provide ads to particular publishers, analyze financial information, analyze ad performance, estimate ad traffic, access keyword tools, add graphics and animations to ads, etc.

The OCMS 106 may allow the online content providers 102 to create ads and input keywords or other ad placement descriptors for which those ads will appear. In some examples, the OCMS 106 may provide ads to user access devices or publishers when keywords associated with those ads are included in a user request or requested content. The OCMS 106 may also allow the online content providers 102 to set bids for ads. A bid may represent the maximum amount an advertiser is willing to pay for each ad impression, user click-through of an ad or other interaction with an ad. A click-through can include any action a user takes to select an ad. Other actions include haptic feedback or gyroscopic feedback to generate a click-through. The online content providers 102 may also choose a currency and monthly budget.

The OCMS 106 may also allow the online content providers 102 to view information about ad impressions, which may be maintained by the OCMS 106. The OCMS 106 may be configured to determine and maintain the number of ad impressions relative to a particular website or keyword. The OCMS 106 may also determine and maintain the number of click-throughs for an ad as well as the ratio of click-throughs to impressions.

The OCMS 106 may also allow the online content providers 102 to select and/or create conversion types for ads. A “conversion” may occur when a user consummates a transaction related to a given ad. A conversion could be defined to occur when a user clicks, directly or implicitly (e.g., through haptic or gyroscopic feedback), on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The OCMS 106 may store conversion data and other information in a conversion data repository 136.

The OCMS 106 may allow the online content providers 102 to input description information associated with ads. This information could be used to assist the publishers 104 in determining ads to publish. The online content providers 102 may additionally input a cost/value associated with selected conversion types, such as a five dollar credit to the publishers 104 for each product or service purchased.

The OCMS 106 may provide various features to the publishers 104. The OCMS 106 may deliver ads (associated with the online content providers 102) to the user access devices 108 when users access content from the publishers 104. The OCMS 106 can be configured to deliver ads that are relevant to publisher sites, site content, and publisher audiences.

In some examples, the OCMS 106 may crawl content provided by the publishers 104 and deliver ads that are relevant to publisher sites, site content and publisher audiences based on the crawled content. The OCMS 106 may also selectively recommend and/or provide ads based on user information and behavior, such as particular search queries performed on a search engine website, or a designation of an ad for subsequent review, as described herein, etc. The OCMS 106 may store user-related information in a general database 146. In some examples, the OCMS 106 can add search services to a publisher site and deliver ads configured to provide appropriate and relevant content relative to search results generated by requests from visitors of the publisher site. A combination of these and other approaches can be used to deliver relevant ads.

The OCMS 106 may allow the publishers 104 to search and select specific products and services as well as associated ads to be displayed with content provided by the publishers 104. For example, the publishers 104 may search through ads in the ad repository 126 and select certain ads for display with their content.

The OCMS 106 may be configured to selectively recommend and provide ads created by the online content providers 102 to the user access devices 108 directly or through the publishers 104. The OCMS 106 may selectively recommend and provide ads to a particular publisher 104 (as described in further detail herein) or a requesting user access device 108 when a user requests search results or loads content from the publisher 104.

In some implementations, the OCMS 106 may manage and process financial transactions among and between elements in the environment 100. For example, the OCMS 106 may credit accounts associated with the publishers 104 and debit accounts of the online content providers 102. These and other transactions may be based on conversion data, impressions information and/or click-through rates received and maintained by the OCMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed online content providers 102, publishers 104 and/or user access devices 108, which may be discrete, integrated modules or distributed systems. Similarly, the environment 100 is not limited to a single OCMS 106 and may include any number of integrated or distributed AMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

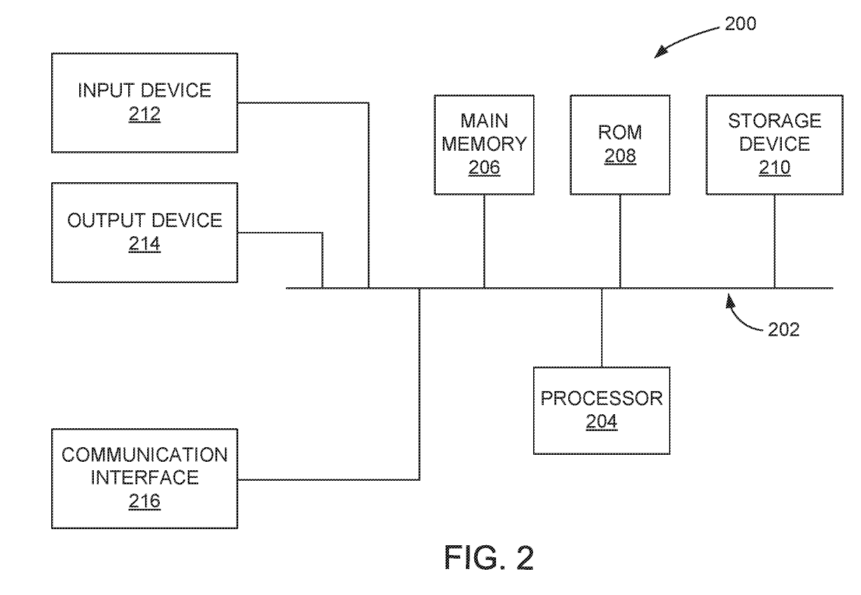

FIG. 2 is a block diagram of a computing device 200 used for managing, providing, displaying, and analyzing voice-interactive online content, as shown in the online content environment 100 (shown in FIG. 1). Computing device 200 is intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document. Accordingly, computing device 200 may represent user computing device, content management computing device, online content provider computing devices, and online content publishing computing devices (none shown in FIG. 2). As described, all of user computing device, content management computing device, online content provider computing devices, and online content publishing computing devices may be in networked communication using the system capabilities described in FIG. 2.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

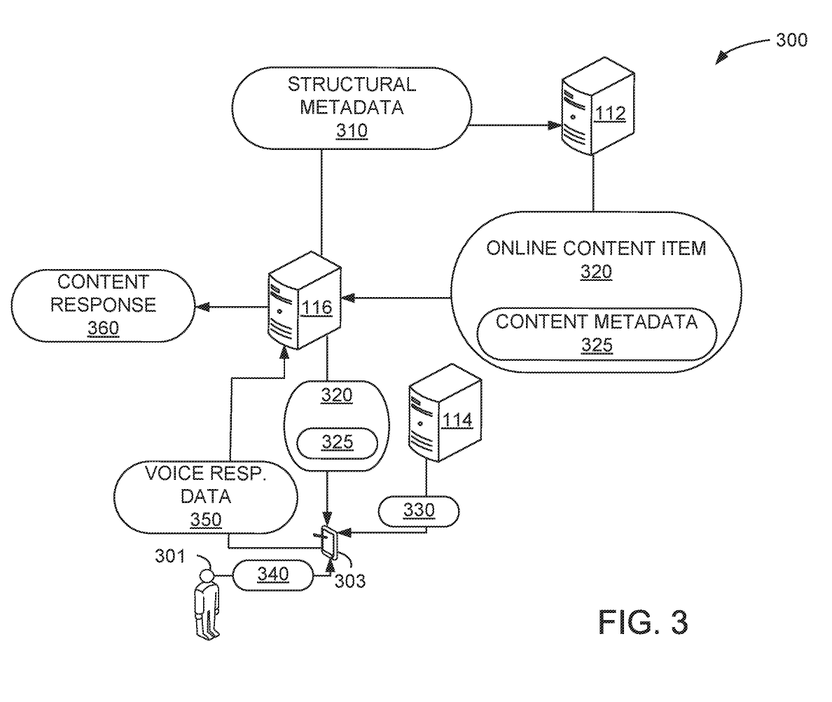

FIG. 3 is an example data flowchart 300 of managing and providing voice-interactive online content using computing devices 112, 116, 303, and 114 in the online content environment 100 (shown in FIG. 1.) As described in FIG. 2, the structures of computing devices 112, 116, 303, and 104 are similar to those of computing device 200.

Content management computing device 116 defines structural metadata 310 that may be used to create content metadata 325, as described above. Content management computing device 116 provides structural metadata 310 to a plurality of systems including online content provider computing device 112. Online content provider computing device 112 uses structural metadata 310 to create content metadata 325 and serve online content item 320 including content metadata 325. More specifically, as described above, content metadata 325 associates online content item 320 with at least on voice interaction type.

Content management computing device 116 identifies at least one voice interaction associated with content metadata 325 online content item 320 including content metadata 325 to user computing device 303. Content management computing device 116 serves online content item 320 by also instructing user computing device 303 to collect voice response data 350 that is responsive to the identified at least one voice interaction.

In some examples, online publisher computing device 114 also serves publication 330 to user computing device 303 in conjunction with online content item 320.

User computing device 303 displays and/or provides online content item 320 to user 301 and also serves the at least one voice interaction to user 301. User 301 provides user input 340 that is processed into voice response data 350.

Content management computing device 116 receives voice response data 350 and identifies a user request based on voice response data 350. Content management computing device 116 also generates content response 360 based on voice response data 350 and transmits it to a suitable party including at least one of user computing device 303, online content provider computing device 112, online publisher computing device 114, and other systems (not shown).

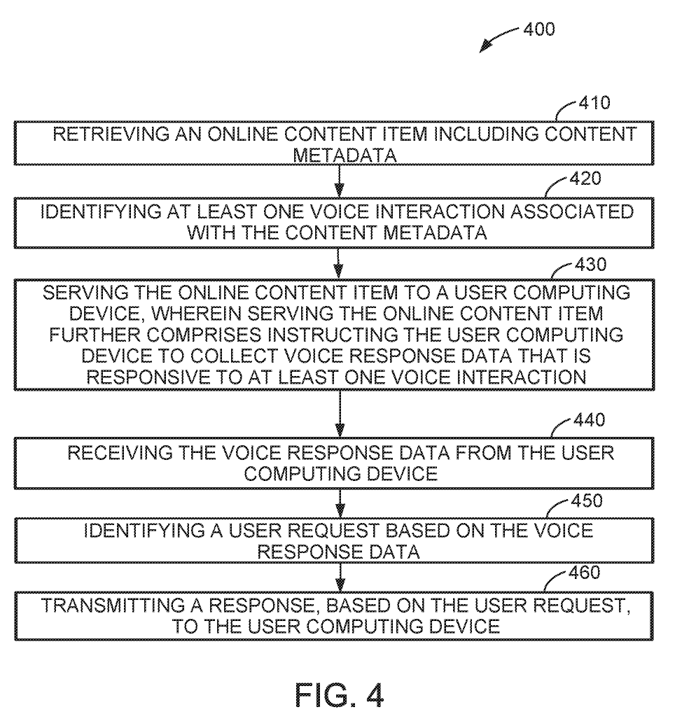

FIG. 4 is an example method 400 for managing and providing voice-interactive online content using online content environment 100 (shown in FIG. 1) In the example embodiment, method 400 is performed by content management computing device 116 (shown in FIG. 3). In alternative embodiments, as described above, some steps of method 400 may also employ other systems including user computing device 303 (shown in FIG. 3).

Content management computing device 116 retrieves 410 an online content item including content metadata such as online content item 320 including online content metadata 325.

Content management computing device 116 also identifies 420 at least one voice interaction associated with content metadata 325 and serves 430 online content item 320 to a user computing device (such as user computing device 303 (shown in FIG. 3). Serving online content item 320 further comprises instructing user computing device 303 to collect voice response data 350 (shown in FIG. 3) that is responsive to at least one voice interaction.

Content management computing device 116 also receives 440 voice response data 350 from user computing device 303 and identifies 450 a user request based on the voice response data 350. Content management computing device 116 also transmits 460 a response, based on the user request, to user computing device 303.

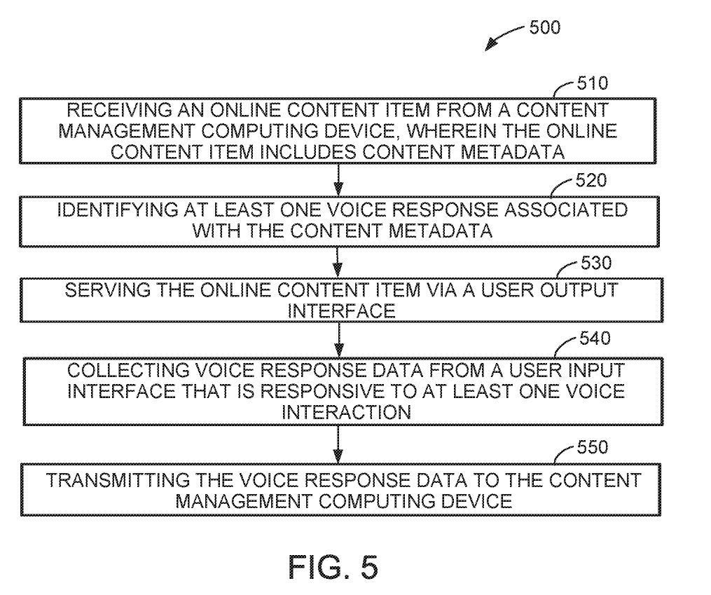

FIG. 5 is an example method of displaying and providing voice-interactive online content to user computing device of 303 (shown in FIG. 3) using online content environment 100 (shown in FIG. 1). User computing device 303 is configured to receive 510 an online content item 320 (shown in FIG. 3) from a content management computing device 116 (shown in FIG. 3), wherein online content item 320 includes content metadata 325 (shown in FIG. 3). User computing device 303 is also configured to identify 520 at least one voice interaction associated with the content metadata 325. User computing device 303 is further configured to serve 530 online content item 320 via a user output interface. User computing device 303 is additionally configured to collect 540 voice response data 350 (shown in FIG. 3) from a user input interface that is responsive to at least one voice interaction. User computing device 303 is also configured to transmit 550 the voice response data 350 to the content management computing device 116.

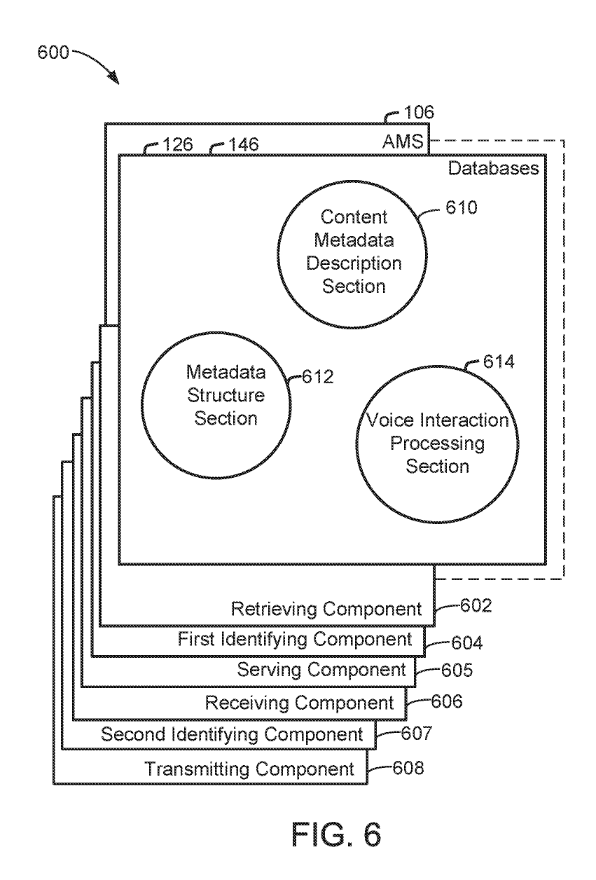

FIG. 6 is a diagram 600 of components of one or more example computing devices, for managing and providing voice-interactive online content.

For example, one or more of computing devices 200 may form advertising management system (AMS) 106, customer computing device 108 (both shown in FIG. 1), content management computing device 116, and user computing device 303 (both shown in FIG. 3). FIG. 6 further shows a configuration of databases 126 and 146 (shown in FIG. 1). Databases 126 and 146 are coupled to several separate components within content management computing device 120, content provider data processing system 112, and customer computing device 108, which perform specific tasks.

Content management computing device 120 includes a retrieving component 602 for retrieving an online content item including content metadata. Content management computing device 120 includes a first identifying component 604 for identifying at least one voice interaction associated with the content metadata. Content management computing device 120 includes a serving component 605 for serving the online content item to a user computing device, wherein serving the online content item further comprises instructing the user computing device to collect voice response data that is responsive to at least one voice interaction. Content management computing device 120 includes a receiving component 606 for receiving the voice response data from the user computing device. Content management computing device 120 includes a second identifying component 607 for identifying a user request based on the voice response data. Content management computing device 120 includes a transmitting component 608 for transmitting a response, based on the user request, to the user account.

In an exemplary embodiment, databases 126 and 146 are divided into a plurality of sections, including but not limited to, a content metadata description section 610, a metadata structure section 612, and a voice interaction processing section 614. These sections within database 126 and 146 are interconnected to update and retrieve the information as required.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the subject matter described herein or its features may have different names, formats, or protocols. Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

1. (canceled)

2. A system, comprising:
a memory device storing data, including machine executable instructions; and
one or more processors in communication with the memory device, wherein the processor is configured to execute the executable instructions, which cause the one or more processors to perform operations, including:
retrieving an online content item including content metadata that designates one or more interaction labels of one or more voice interactions that are enabled for the online content item;
causing a client device to present the online content item at a client device and listen for an audio response from a user for a specified amount of time following presentation of the online content item;
detecting a particular audio response submitted through the client device;
determining that the audio response matches a particular voice interaction label, among the one or more interaction labels;
deferring, in response to determining that the audio response matches the particular voice interaction label, interaction with the user to a later time, including transmitting additional information to an account of the user rather than responding to the audio response with the additional information.

3. The system of claim 2, wherein the instructions cause the one or more processors to request an additional audio response form the user prior to deferring the interaction, wherein deferring the interaction is performed in response to determining that the audio response matches the particular voice interaction label and the additional audio response received from the user provides information required to transmit the additional information to the account of the user.

4. The system of claim 2, wherein the instructions cause the one or more processors to perform operations comprising:
processing the particular audio response into a set of text data using a speech processing algorithm; and
identifying the particular voice interaction label from the set of text data by applying at least one of a regular expression algorithm and a context-free grammar algorithm.

5. The system of claim 2, wherein the instructions cause the one or more processors to perform operations comprising:
determining that the audio response represents a request for an offer; and
retrieving at least a set of contact data for the user from a profile of the user, wherein:
transmitting the response comprises transmitting the response using the contact data for the user.

6. The system of claim 2, wherein the instructions cause the one or more processors to perform operations comprising:
determining that the audible response represents a request for a purchase;
retrieving a set of payment information for the user; and
initiating an order based on the set of payment information and the request for purchase.

7. The system of claim 6, wherein transmitting additional information to an account of the user comprises transmitting order details to the account of the user, wherein the order details enable the user to review, approve, cancel, or modify the order.

8. The system of claim 2, wherein the instructions cause the one or more processors to perform operations comprising:
determining that the audio response represents a request to a scheduled event; and
identifying a set of calendar options for the user, wherein:
transmitting the additional information comprises transmitting information about the scheduled event based on the set of calendar options.

9. A method, comprising:
retrieving, by one or more processors, an online content item including content metadata that designates one or more interaction labels of one or more voice interactions that are enabled for the online content item;
causing, by the one or more processors, a client device to present the online content item at a client device and listen for an audio response from a user for a specified amount of time following presentation of the online content item;
detecting, by the one or more processors, a particular audio response submitted through the client device;
determining, by the one or more processors, that the audio response matches a particular voice interaction label, among the one or more interaction labels;
deferring, by the one or more processors and in response to determining that the audio response matches the particular voice interaction label, interaction with the user to a later time, including transmitting additional information to an account of the user rather than responding to the audio response with the additional information.

10. The method of claim 9, further comprising:
requesting an additional audio response form the user prior to deferring the interaction, wherein deferring the interaction is performed in response to determining that the audio response matches the particular voice interaction label and the additional audio response received from the user provides information required to transmit the additional information to the account of the user.

11. The method of claim 9, further comprising:
processing the particular audio response into a set of text data using a speech processing algorithm; and
identifying the particular voice interaction label from the set of text data by applying at least one of a regular expression algorithm and a context-free grammar algorithm.

12. The method of claim 9, further comprising:
determining that the audio response represents a request for an offer; and
retrieving at least a set of contact data for the user from a profile of the user, wherein:
transmitting the response comprises transmitting the response using the contact data for the user.

13. The method of claim 9, further comprising:
determining that the audible response represents a request for a purchase;
retrieving a set of payment information for the user; and
initiating an order based on the set of payment information and the request for purchase.

14. The method of claim 13, wherein transmitting additional information to an account of the user comprises transmitting order details to the account of the user, and wherein the order details enable the user to review, approve, cancel, or modify the order.

15. The method of claim 9, further comprising:
determining that the audio response represents a request to a scheduled event; and
identifying a set of calendar options for the user, wherein:
transmitting the additional information comprises transmitting information about the scheduled event based on the set of calendar options.

16. A non-transitory computer-readable storage device, storing processor-executable instructions that, when executed by one or more processors, cause the one or more processors to perform operations including:
retrieving an online content item including content metadata that designates one or more interaction labels of one or more voice interactions that are enabled for the online content item;
causing a client device to present the online content item at a client device and listen for an audio response from a user for a specified amount of time following presentation of the online content item;
detecting a particular audio response submitted through the client device;
determining that the audio response matches a particular voice interaction label, among the one or more interaction labels;
deferring, in response to determining that the audio response matches the particular voice interaction label, interaction with the user to a later time, including transmitting additional information to an account of the user rather than responding to the audio response with the additional information.

17. The non-transitory computer-readable storage device of claim 16, wherein the instructions cause the one or more processors to request an additional audio response form the user prior to deferring the interaction, wherein deferring the interaction is performed in response to determining that the audio response matches the particular voice interaction label and the additional audio response received from the user provides information required to transmit the additional information to the account of the user.

18. The non-transitory computer-readable storage device of claim 16, wherein the instructions cause the one or more processors to perform operations comprising:
processing the particular audio response into a set of text data using a speech processing algorithm; and
identifying the particular voice interaction label from the set of text data by applying at least one of a regular expression algorithm and a context-free grammar algorithm.

19. The non-transitory computer-readable storage device of claim 16, wherein the instructions cause the one or more processors to perform operations comprising:
determining that the audio response represents a request for an offer; and
retrieving at least a set of contact data for the user from a profile of the user, wherein:
transmitting the response comprises transmitting the response using the contact data for the user.

20. The non-transitory computer-readable storage device of claim 16, wherein the instructions cause the one or more processors to perform operations comprising:
determining that the audible response represents a request for a purchase;
retrieving a set of payment information for the user; and
initiating an order based on the set of payment information and the request for purchase.

21. The non-transitory computer-readable storage device of claim 20, wherein transmitting additional information to an account of the user comprises transmitting order details to the account of the user, wherein the order details enable the user to review, approve, cancel, or modify the order.
